(19) United States
(12) Patent Application Publication
(10) Pub. No.: US 2012/0227400 A1
(43) Pub. Date: Sep. 13, 2012

(54) METHOD AND SYSTEM FOR IMPROVING EFFICIENCY OF MULTISTAGE TURBOCHARGER

(75) Inventors: Rodrigo Rodriguez Erdmenger, Munich (DE); Alberto Scotti Del Greco, Figline Valdarno (IT); Vittorio Michelassi, Munich (DE); Kendall Roger Swenson, Erie, PA (US); Daniel Edward Loringer, Erie, PA (US); Mark Thomas Stablein, Erie, PA (US); Lukas William Johnson, Erie, PA (US)

(73) Assignee: GENERAL ELECTRIC COMPANY, SCHENECTADY, NY (US)

(21) Appl. No.: 13/043,826

(22) Filed: Mar. 9, 2011

(51) Int. Cl. F02C 6/12

(52) U.S. Cl. 60/612

(57) ABSTRACT

A turbine system for a multistage turbocharger and a method for utilizing the same are disclosed. The turbine system includes a high pressure turbine having an inlet for receiving a flow of fluid, and an outlet for passing the flow on extraction of work from the high pressure turbine. The system further includes a low pressure turbine, having an inlet for receiving a flow of fluid from the high pressure turbine. A diffuser connects the outlet of the high pressure turbine and the inlet of the low pressure turbine. The system also includes a bypass channel for bypassing a portion of the flow around the high pressure turbine, from upstream of the high pressure turbine to downstream of the high pressure turbine. The system includes an injector to input the bypass flow in the diffuser in a manner to reduce flow separation in the diffuser.

### BACKGROUND

Two-stage turbo charging systems, such as for use with internal combustion engines, are well-known in the art. Two-stage turbocharger includes a high pressure turbocharger and a low pressure turbocharger. The high pressure turbocharger (high pressure stage) includes a high pressure turbine coupled to a compressor. Similarly, the low pressure turbocharger includes a low pressure turbine coupled to a compressor. The turbine operates by receiving exhaust gas from an internal combustion engine and converting a portion of the energy in that exhaust gas stream into mechanical energy by passing the exhaust stream over blades of a turbine wheel, and thereby causing the turbine wheel to rotate. This rotational force is then utilized by the compressor, coupled by a shaft to the turbine wheel, to compress a quantity of air to a pressure higher than the surrounding atmosphere. This provides an increased amount of air available to be drawn into the internal combustion engine cylinders during the engine's intake stroke. The additional compressed air taken into the cylinders may allow more fuel to be burned within the cylinder, and thereby offers the opportunity to increase the engine's power output.

In certain situations, such as to meet the air flow requirements at part load, it is required to switch between the two turbo charging stages through use of a bypass system to divert exhaust gas flow around the higher pressure turbocharger to the lower pressure turbocharger. The by-pass flow is generally known as bleed flow. Generally, the bleed flows on the bypass system are simply injected into the lower pressure turbine in a manner that is convenient from the packaging perspective. However, in such situations bleed flows are injected in a manner which affects the efficiency of the high pressure turbine and the lower pressure turbine. Additionally depending on the turbocharger arrangement the diffuser downstream of the high pressure turbocharger may need to have a very steep angle and/or in some cases large bends, decreasing the efficiency of both the low pressure and the high pressure turbocharger.

For these and other reasons, there is a need for embodiments of the invention

### BRIEF DESCRIPTION OF THE INVENTION

A turbine system for a multistage turbocharger and a method for utilizing the same are disclosed. The turbine system includes a high pressure turbine having an inlet for receiving a flow of fluid, and an outlet for passing the flow on extraction of work from the high pressure turbine. A low pressure turbine, downstream of the high pressure turbine, having an inlet for receiving a flow of fluid from downstream of the high pressure turbine. A diffuser connecting the outlet of the high pressure turbine and the inlet of the low pressure turbine. A bypass for bypassing a portion of the flow around the high pressure turbine, from upstream of the high pressure turbine to downstream of the high pressure turbine. An injector to input the bypass flow in the diffuser in a manner to reduce flow separation in the diffuser.

### BRIEF DESCRIPTION OF DRAWINGS

FIG. 1 illustrates a schematic diagram of an internal combustion engine with a multistage turbocharger, according to an embodiment of the present invention;

FIG. 2 illustrates an injector for injecting bypass flow in a diffuser, according to an embodiment of the present invention;

FIG. 3 illustrates another injector for injecting bypass flow in the diffuser, according to an embodiment of the present invention; and

FIG. 4 illustrates a method for increasing efficiency of the multistage turbocharger, according to an embodiment of the present invention.

### DETAILED DESCRIPTION OF THE INVENTION

Embodiments of the present invention provide an improved turbine system for a multistage turbocharger and an internal combustion engine system utilizing the improved turbine system. Embodiments of the present invention further provide a method of increasing efficiency of a multistage turbocharger in an internal combustion engine.

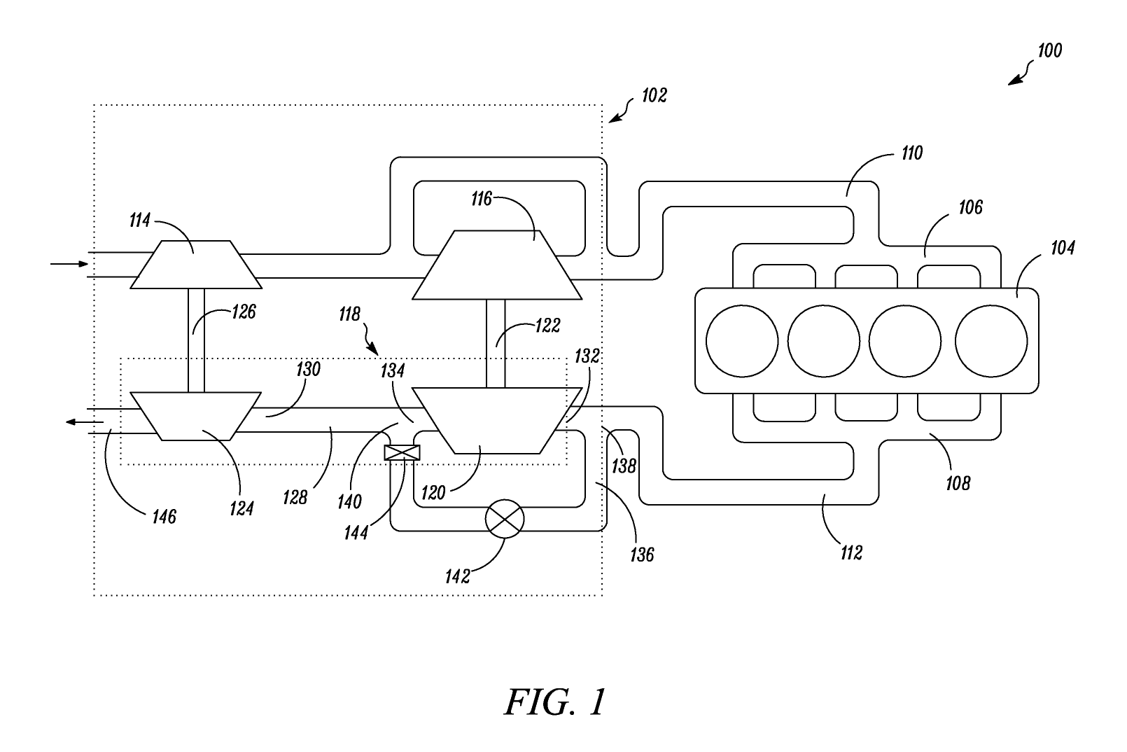

FIG. 1 illustrates a schematic view of an internal combustion engine system 100 with a multistage turbocharger 102. The internal combustion engine system 100 (also referred to as “internal combustion engine 100”) may be an internal combustion diesel engine. The internal combustion engine system 100 may include combustion chambers 104, an intake manifold 106 and an exhaust manifold 108. Each of the intake manifold 106 and the exhaust manifold 108 are fluidly connected to combustion chambers 104. The internal combustion engine 100 further includes an intake line 110 through which intake (ambient) air enters in the intake manifold 106. Similarly, the internal combustion engine 100 includes an exhaust line 112 which is fluidly connected with the exhaust manifold 108 to direct the flow of pressurized exhaust gases produced in combustion chambers 104.

In an embodiment of the present invention, the intake air entering in the internal combustion engine 100 may be optionally mixed with recirculated exhaust gases (EGR) to form a charge-air mixture. The intake air or EGR/intake air mixture (“charge-air”) flows through and is compressed by a low pressure air compressor 114. The low pressure air compressor 114 may be a centrifugal compressor. After compression in the low pressure air compressor 114, the intake air may flow through a high pressure air compressor 116 for further compression. The high pressure air compressor 116 may also be a centrifugal compressor. In an embodiment of the present invention, the intake air may be diverted before it flows through the high pressure air compressor 116 and is fed directly into the intake manifold 106. The internal combustion engine system 100 may optionally also include an inter stage cooler (not illustrated), between the low pressure air compressor 114 and the high pressure air compressor 116 and after cooler (not illustrated) between the high pressure air compressor 116 and the intake manifold 106.

Subsequently, the intake air enters the intake manifold 106 and into the combustion chambers 104 of the internal combustion engine system 100. Following, combustion in the combustion chambers 104 of the internal combustion engine 100, the warm, pressurized exhaust gases leave the combustion chambers 104 at a higher exhaust gas energy level and flow through the exhaust manifold 108 to the exhaust line 112.

These pressurized exhaust gases coming from the exhaust manifold 108 are utilized by the multistage turbocharger 102. The multistage turbocharger 102 includes a turbine system 118. The multistage turbocharger 102 has two stages of turbocharging namely a high pressure turbocharger and a low pressure turbocharger. A high pressure turbine 120 in exhaust line 112 is coupled to the high pressure air compressor 116 in the intake line 110 through a first shaft 122, and together the combined turbine and compressor device forms the high pressure turbocharger. Similarly, a low pressure turbine 124 in the exhaust line 112 is coupled to the low pressure air compressor 114 in intake line 110 through a second shaft 126, and together the turbine and compressor form the low pressure turbocharger.

The turbine system 118 further includes a diffuser 128 downstream of the high pressure turbine 120. The diffuser 128 connects an outlet of the high pressure turbine 120 and an inlet 130 of the low pressure turbine 124. The exhaust gases, on extraction of work, through the high pressure turbocharger flows through the diffuser 128 into the inlet 130 of the low pressure turbine 124. Herein it may be apparent to those skilled in that art that a conventional diffuser, such as the diffuser 128 may be an elongated section, for example. However, other configurations may be possible. The diffuser 128 conventionally, conserves the energy of the exhaust fluid and converts a portion if its kinetic energy into pressure, as the fluid flows through the diffuser 128.

Referring again to FIG. 1, after leaving the exhaust manifold 108, exhaust gas in the exhaust line 112 may flow through an inlet 132, which is fluidly connected with the exhaust line 112, of the high pressure turbine 120. During the passage of the exhaust gas through the high pressure turbine 120, extraction of work from the fluid is done by means of the high pressure air compressor 116 and the exhaust gas is circulated out through an outlet 134 of the high pressure turbine 120 into the diffuser 128, which is connecting the outlet 134 of the high pressure turbine 120 and the inlet 130 of the low pressure turbine 124. Subsequently, the inlet 130 of the low pressure turbine 124, positioned downstream of the high pressure turbine 120, receives the flow of the exhaust gases from the diffuser 128. Thus, the exhaust gases may further expand in the low pressure turbine 124 before the exhaust gases are circulated out of the internal combustion engine 100 through an outlet 146.

Alternatively, depending on the various load conditions it may required to divert a portion of the exhaust gases upstream of the high pressure turbine 120 to downstream of the high pressure turbine 120. Thus, the turbine system 118 further includes a bypass channel 136 to divert a portion of the exhaust gases from upstream of the high pressure turbine 120. The bypass channel 136 extends from the exhaust line 112, from upstream of the high pressure turbine 120, to connect with the diffuser 128, downstream of the high pressure turbine 120. Specifically, a first end portion 138 of the bypass channel 136 is connected to the exhaust line 112 and a second end portion 140 of the bypass channel 136 is connected to the diffuser 128. Further, the bypass channel 136 may include a control valve 142 that, depending upon the load conditions regulates the portion of the exhaust gases that must be diverted from upstream of the high pressure turbine 120. The control valve 142, in an open condition thereof, directs a portion of the exhaust gases coming from the exhaust line 112 through the bypass channel 136, thereby precluding the entire exhaust gases from entering the high pressure turbine 120.

The exhaust gases circulated out from the outlet 134 of the high pressure turbine 120 and the bypassed exhaust gases mix inside the diffuser 128 before the exhaust gases enters the low pressure turbine 124. The flow coming from the high pressure turbine 120 and/or from the bypass channel 136 may be turbulent. In such cases, diffuser 128 may experience boundary layer formation, flow separation and thus experience losses, such as but not limited to, pressure loss etc. Such losses may substantially hamper the performance of the turbines. In an embodiment of the present invention, the bypass channel 136 further includes an injector 144 to inject the bypass flow into the diffuser 128. The injector 144 inputs the bypassed flow in the diffuser 128 in a manner to reduce flow separation in the diffuser 128.

The injector 144 is designed such that the injection of the bypassed flow in the diffuser 128 reduces the flow separation in the diffuser 128. Moreover, the reduced flow separation in the diffuser 128 may enable the assembly of the high pressure turbine 120 and the low pressure turbine 124 closer together. Thus, the diffuser 128 may be relatively short in length. Alternatively, the diffuser 128 may be designed with more aggressive bends, and thus occupy less space. Advantageously, the assembly of the high pressure turbine 120 and the low pressure turbine 124 closer together may enable a more compact packing of the internal combustion engine 100.

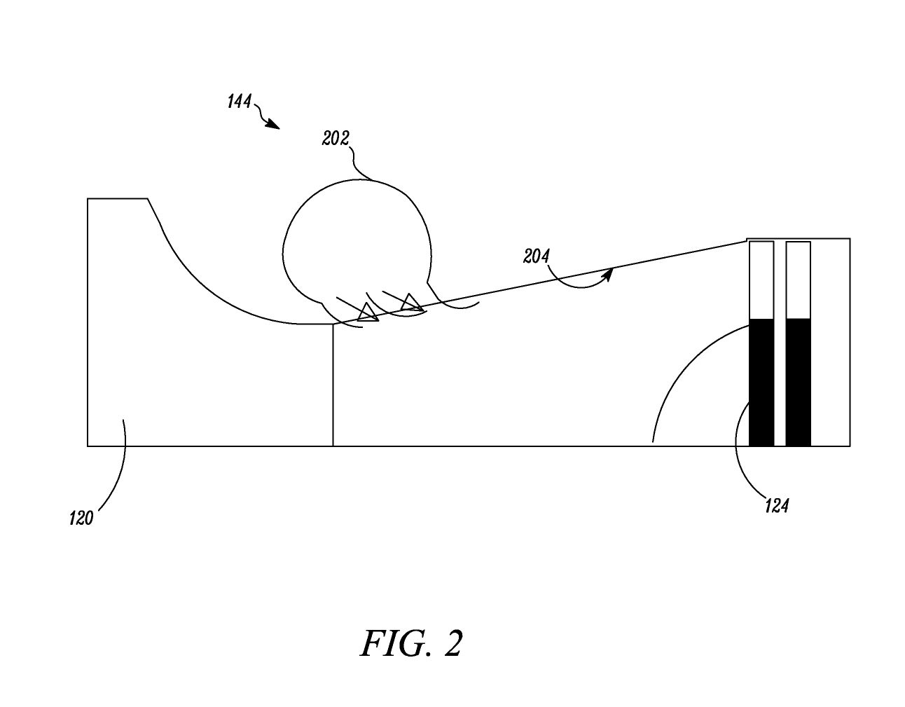

FIG. 2 illustrates the injector 144 for injecting bypass flow in the diffuser 128, according to an embodiment of the present invention. In the exemplary embodiment of the FIG. 2, the injector 144 includes a half volute 202. The half volute 202 may inject the bypassed flow at an angle to at least one surface wall 204 of the diffuser 128. Specifically, the half volute 202 may inject the bypassed flow into the diffuser 128 along the surface wall 204 of the diffuser 128. The bypassed flow, injected in the diffuser 128, may push the flow of exhaust gases received from the high pressure turbine 120 towards the inlet 130 of the low pressure turbine 124. The formation of the boundary layer may result in the flow velocity at the internal boundary (or surface wall 204) of the diffuser 128 tending to be less. However, the flow injected by the half volute 202 along the surface wall 204 reenergizes the flow of the exhaust gases received from the high pressure turbine 120, which in turn reduces the formation of the boundary layer, and thus minimizes the pressure losses. Further, the bypassed flow injected by the half volute 202 may also allow having a much steeper/higher angle at the connection between the high pressure turbine 120 and the low pressure turbine 124 and thus provides compact design and packing advantages.

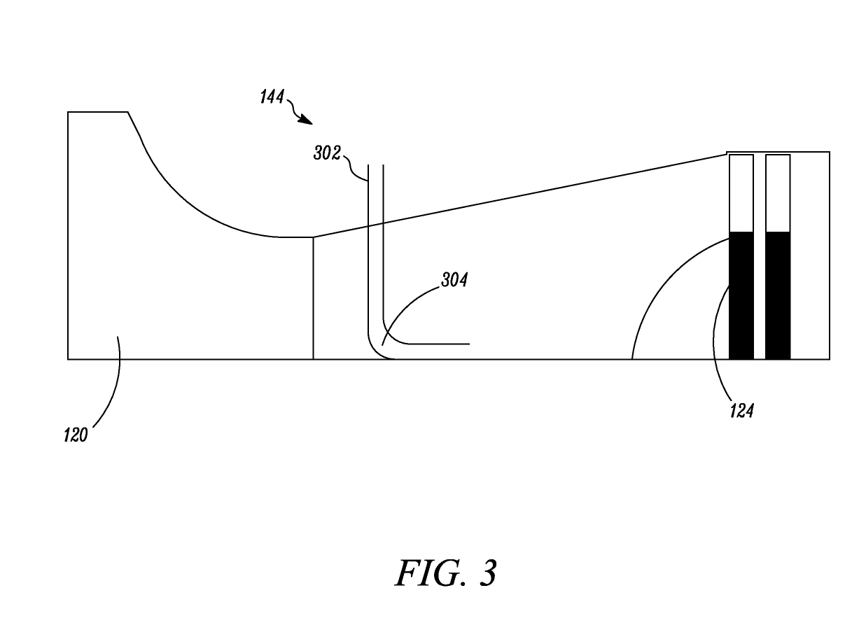

FIG. 3 illustrates another injector 144 for injecting bypassed flow in the diffuser 128, according to an embodiment of the present invention. In the exemplary embodiment of the FIG. 3, the injector 144 includes a pipe 302 which is bolted to the diffuser 128 and having approximately 90 degrees towards an inlet 304. In another embodiment of the present invention, the injector 144 may include a nozzle (not illustrated). The nozzle may be a variable geometry valve. In one embodiment, the injector 144 may inject the bypassed flow at a swirl angle to the flow of the exhaust gases received from the high pressure turbine 120. The injection of the bypassed flow at the swirl angle may reenergize the flow of the exhaust gases received from the high pressure turbine 120 and thus minimize losses which may have arisen due to flow separation in the diffuser 128. In another embodiment, the injector 144 may inject the bypassed flow towards the center of a longitudinal axis of the diffuser 128. The injected flow may accelerate the flow of the exhaust gases received from the high pressure turbine 120 and thus minimize losses which may have arisen due to flow separation in the diffuser 128.

The various embodiments explained herein are non-limiting exemplary embodiments and there can be other methods and configurations employed as the injector to reduce flow separation in the diffuser.

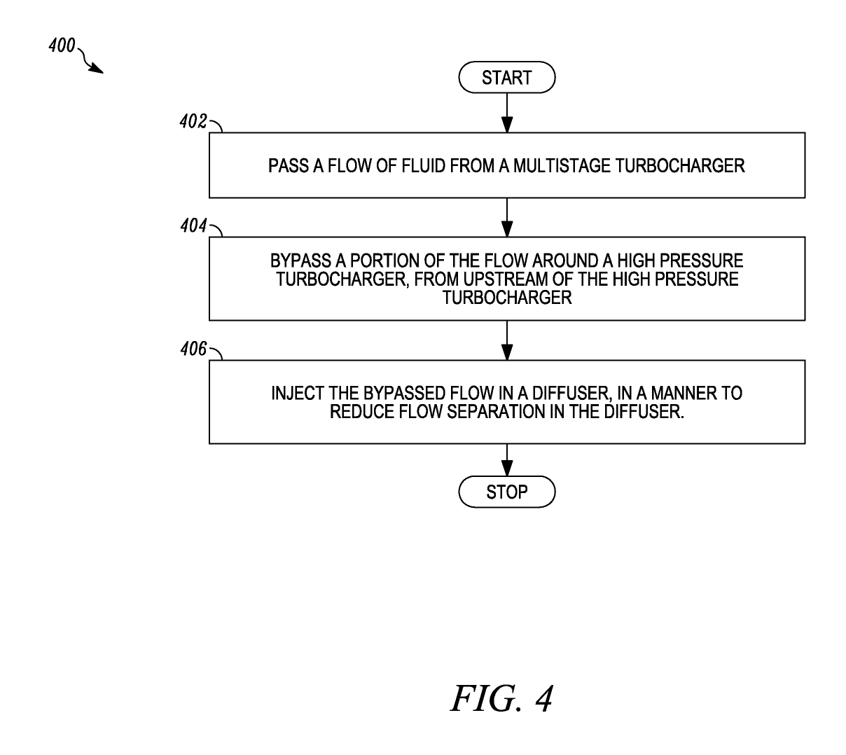

FIG. 4 illustrates a method 400 for increasing efficiency of the multistage turbocharger 102, according to an embodiment of the present invention. The method 400 may be applied on an internal combustion engine system, such as the internal combustion engine 100 employing an exhaust gas recirculation system. The internal combustion engine system 100 may include combustion chambers 104, the intake manifold 106 and the exhaust manifold 108. Each of the intake manifold 106 and the exhaust manifold 108 are fluidly connected to combustion chambers 104. The internal combustion engine 100 also includes the intake line 110 through which intake air may enter in the intake manifold 106. Similarly, the internal combustion engine 100 includes the exhaust line 112 which is fluidly connected with the exhaust manifold 108 to direct the flow of pressurized exhaust gases produced in combustion chambers 104.

The intake air enters the intake manifold 106 and into combustion chambers 104 of the internal combustion engine system 100. Following, combustion in combustion chambers 104 of the internal combustion engine 100, the warm, pressurized exhaust gases leave the combustion chambers 104 at a higher exhaust gas energy level and flow through the exhaust manifold 108 to the exhaust line 112.

At step 402, pressurized exhaust gases coming from the exhaust manifold 108 are passed through the multistage turbocharger 102. The multistage turbocharger 102 has two stages of turbocharging namely the high pressure turbocharger and the low pressure turbocharger. The high pressure turbine 120 in exhaust line 112 is coupled to the high pressure air compressor 116 in the intake line 110 through the first shaft 122, and together the combined turbine and compressor device forms the high pressure turbocharger. Similarly, the low pressure turbine 124 in exhaust line 112 is coupled to the low pressure air compressor 114 in the intake line 110 through the second shaft 126, and together the turbine and compressor form the low pressure turbocharger.

The turbine system 118 further includes the diffuser 128, downstream of the high pressure turbine 120 that connects the outlet 134 of the high pressure turbine 120 and the inlet 130 of the low pressure turbine 124. The exhaust gases, after extraction of work, through the high pressure turbocharger flows through the diffuser 128 into the inlet 130 of the low pressure turbine 124.

After leaving the exhaust manifold 108, exhaust gases in exhaust line 112 may flow through the inlet 132, which is fluidly connected with the exhaust line 112, of the high pressure turbine 120. During the passage of the exhaust gas through the high pressure turbine 120, extraction of work from the fluid is done by means of the high pressure air compressor 116 and the exhaust gas is circulated out through the outlet 134 of the high pressure turbine 120 into the diffuser 128 connecting the high pressure turbine 120 and the low pressure turbine 124. Subsequently, the inlet 130 of the low pressure turbine 124, positioned on a downstream of the high pressure turbine 120, receives the flow of the exhaust gases from the diffuser 128. Thus, the exhaust gases may further expand in the low pressure turbine 124 before the exhaust gases are circulated out of the internal combustion engine 100 through the outlet 146.

Alternatively, at step 404, depending on the various load conditions, a portion of the exhaust gas is bypassed from an upstream of the high pressure turbine 120. The turbine system includes the bypass channel 136 to divert a portion of the exhaust gases upstream of the high pressure turbine 120. The bypass channel 136 extends from the exhaust line 112, from upstream of the high pressure turbine 120, to connect with the diffuser 128, downstream of the high pressure turbine 120. Further, the bypass channel 136 includes the control valve 142 that regulates, depending upon the load conditions, the portion of the exhaust gases that must be diverted from upstream of the high pressure turbine 120. The control valve 142, in an open condition thereof, directs a portion of the exhaust gases coming from the exhaust line 112 through the bypass channel 136, thereby precluding the entire exhaust gases from entering the high pressure turbine 120.

The exhaust gases circulated out from the outlet 134 of the high pressure turbine 120 and the bypass flow mix inside the diffuser 128 before the exhaust gases enters the low pressure turbine 124. The flow coming from the high pressure turbine 120 and/or the bypass channel 136 may be turbulent. In such cases, the diffuser 128 may experience boundary layer formation, flow separation and thus experience losses, such as but not limited to, pressure loss etc. Such losses may substantially hamper the performance of the turbines. In an embodiment of the present invention, the bypass channel 136 further includes the injector 144 for injecting the bypass flow into the diffuser 128.

At step 406, the injector 144 inputs the bypass flow in the diffuser 128 in a manner to reduce flow separation in the diffuser 128. The injector 144 is designed such that the injection of the bypass flow in the diffuser 128 reduces the flow separation in the diffuser 128. Thus, the losses occurring in the fluid during its passage through the diffuser 128 get reduced. Moreover, the reduced flow separation in the diffuser 128 may enable the assembly of the high pressure stage and the low pressure stage closer together. Thus, the diffuser 128 may be relatively short in length. Alternatively, the diffuser 128 may have a ninety degree bent and thus occupy less space. Advantageously, the assembly of the high pressure stage and the low pressure stage closer together may enable a more compact packing of the internal combustion engine 100. In an embodiment of the present invention, the bypass flow is injected at an angle to at least one surface wall 204 of the diffuser 128. The bypass flow on injected in the diffuser 128 may push the flow received from the high pressure turbine 120 towards the inlet 130 of the low pressure turbine 124. In another embodiment of the present invention, the bypass flow is injected at a swirl angle to the flow received from the high pressure turbine 120. In yet another embodiment, the bypass flow is injected towards the center of a longitudinal axis of the diffuser 128. It may be apparent to those skilled in the art that due to the formation of the boundary layer, the flow velocity at the internal boundary of the diffuser 128 tends to be less. However, the injector 144 of the present invention is designed in such a manner that the injected flow may re-energizes the flow from the high pressure turbine 120, which reduces the formation of the boundary layer, and thus minimizes the pressure losses. Further, the injected bypass flow may also allow having a much steeper/higher angle at the connection between the high pressure turbine 120 and the low pressure turbine 124 and thus leads to compact design and packing advantages.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A turbine system for a multistage turbocharger, comprising:
a high pressure turbine having an inlet for receiving a flow of fluid, and an outlet for passing the flow on extraction of work from the high pressure turbine;
a low pressure turbine, downstream of the high pressure turbine, having an inlet for receiving a flow of fluid from downstream of the high pressure turbine;
a diffuser, downstream of the high pressure turbine, connecting the outlet of the high pressure turbine and the inlet of the low pressure turbine;
a bypass channel for bypassing a portion of the flow around the high pressure turbine, from upstream of the high pressure turbine to downstream of the high pressure turbine; and
an injector to input the bypass flow in the diffuser in a manner to reduce flow separation in the diffuser.

2. The turbine system of claim 1, where in the injector injects the bypass flow in the diffuser at a swirl angle to the flow received from the outlet of the high pressure turbine.

3. The turbine system of claim 1, wherein the injector comprises a nozzle.

4. The turbine system of claim 3, wherein the nozzle is a variable geometry valve.

5. The turbine system of claim 3, wherein the nozzle injects the bypass flow towards the centre of a longitudinal axis of the diffuser.

6. The turbine system of claim 1, wherein the injector comprises a half volute.

7. The turbine system of claim 6, wherein the half volute injects the bypass flow at an angle to at least one surface wall of the diffuser.

8. The turbine system of claim 1, wherein the bypass flow on injected in the diffuser pushes the flow received from the high pressure turbine towards the inlet of the low pressure turbine.

9. An internal combustion engine system, comprising:
an internal combustion engine, producing pressurized exhaust gases;
an exhaust line fluidly connected to the internal combustion engine, for directing flow of the pressurized exhaust gas;
a high pressure turbine having an inlet for receiving pressurized exhaust gases from the exhaust line and an outlet for passing the pressurized exhaust gases on extraction of work from the high pressure turbine;
a low pressure turbine, downstream of the high pressure turbine, having an inlet for receiving the pressurized exhaust gases from downstream of the high pressure turbine;
a diffuser, downstream of the high pressure turbine, connecting the outlet of the high pressure turbine and the inlet of the low pressure turbine;
a bypass channel for bypassing a portion of the pressurized exhaust gases around the high pressure turbine, from upstream of the high pressure turbine to the downstream of the high pressure turbine; and
an injector to input the bypass flow in the diffuser in a manner to reduce flow separation in the diffuser.

10. The turbine system of claim 9, wherein the injector input the bypass flow in the diffuser at a swirl angle to the pressurized exhaust gas flow received from the outlet of the high pressure turbine.

11. The turbine system of claim 9, wherein the injector comprises a nozzle.

12. The turbine system of claim 11, wherein the nozzle is a variable geometry valve.

13. The turbine system of claim 11, wherein the nozzle injects the bypass flow towards the centre of a longitudinal axis of the diffuser.

14. The turbine system of claim 9, wherein the injector comprises a half volute.

15. The turbine system of claim 14, wherein the half volute injects the bypass flow at an angle to the surface wall of the diffuser.

16. The turbine system of claim 9, wherein the bypass flow on injected in the diffuser pushes the pressurized exhaust gas flow received from the high pressure turbine towards the inlet of the low pressure turbine.

17. A method, comprising:
passing a flow of fluid from a multistage turbocharger having a high pressure turbocharger and a low pressure turbocharger;
bypassing a portion of the flow around the high pressure turbocharger, from upstream of the high pressure turbocharger; and
injecting the bypassed flow in a diffuser, downstream of the high pressure turbocharger, the diffuser connecting an outlet of a turbine of the high pressure turbocharger and an inlet of a turbine of the low pressure turbocharger, wherein the flow is injected in a manner to reduce flow separation in the diffuser.

18. The method of claim 17, wherein injecting the bypassed flow in the diffuser comprises injecting the bypassed flow at a swirl angle to the flow received from the outlet of the turbine of the high pressure turbocharger.

19. The method of claim 17, wherein injecting the bypassed flow in the diffuser comprises injecting the bypassed flow towards the centre of a longitudinal axis of the diffuser.

20. The method of claim 17, wherein injecting the bypassed flow in the diffuser comprises injecting the bypassed flow at an angle to at least one surface wall of the diffuser.
